(19) United States
(12) Patent Application Publication
(10) Pub. No.: US 2020/0110787 A1
(43) Pub. Date: Apr. 9, 2020

(54) ARCHITECTURALLY-DISTRIBUTED APPARATUS AND METHOD TO FORM AND LEVERAGE CLUSTERED CONTENT

(71) Applicant: Walmart Apollo, LLC, Bentonville, AR (US)

(72) Inventors: Mani Kanteswara R. Garlapati, Bangalore (IN); Sunil K. Potnuru, Bangalore (IN); Souradip Chakraborty, Bangalore (IN)

(21) Appl. No.: 16/592,634

(22) Filed: Oct. 3, 2019

Related U.S. Application Data
(60) Provisional application No. 62/778,207, filed on Dec. 11, 2018.

(30) Foreign Application Priority Data
Oct. 3, 2018 (IN) 201841037275

(51) Int. Cl. G06F 16/9536; G06F 16/25; G06F 16/248; G06F 16/22; G06F 16/2458; G06F 16/9535; G06F 17/16

(52) U.S. Cl. CPC G06F 16/9536; G06F 16/252; G06F 16/248; G06Q 50/01; G06F 16/2468; G06F 16/9535; G06F 17/16; G06F 16/2237

(57) ABSTRACT

A plurality of items are automatically clusterized at a first location. Social media postings for a given person are monitored and assessed at a second location in order to detect a trigger state. Upon detecting the trigger state the two locations automatically communicate with one another to identify one or more of the clusters that is relevant to the social media content. Information regarding items that relate to the identified cluster can then be provided to the user.

### CROSS-REFERENCE TO RELATED APPLICATIONS

This application claims the benefit of Indian Application Number 201841037275, filed Oct. 3, 2018, and U.S. Provisional Application No. 62/778,207, filed Dec. 11, 2018, which are incorporated herein by reference in their entirety.

### TECHNICAL FIELD

These teachings relate generally to multiplatform communications.

### BACKGROUND

Social media platforms are known in the art. Generally speaking, social media are interactive computer-mediated technologies that facilitate the creation and sharing of information, ideas, career interests, and other forms of expression via virtual communities and networks. Social media platforms typically permit and facilitate user-generated content such as text posts or comments, digital photos or videos, and so forth (“postings”). Social media therefore constitutes a readily available, user-friendly, and popular mechanism for users to express their thoughts, preferences, and plans.

Social media postings are sometimes harvested and analyzed in an attempt to identify products, services, or other content that the given user may appreciate. Prior art approaches in these regards, however, can be relatively crude in their application and ultimately annoying and/or unappreciated by the user. For example, a user may post that they recently purchased a particular product and that they approve of the product's performance, following which they begin to receive advertisements to purchase that very product. Having already purchased the product, such an advertisement is both a wasted activity and a potential source of discontent for the user.

In addition, privacy concerns are often given short shrift by those who look to leverage social media postings in such regards. Available privacy controls sometimes provide poor granularity and/or leave the user with a perception that they have inadequate control over availability and use of at least some of their information.

Also, present practices in these regards can be insensitive to bandwidth limitations or concerns. For example, content may be pushed to the user in a fairly arbitrary manner that is generally divorced from any consideration regarding whether the timing and/or the content is otherwise appropriate to the user's circumstances.

### BRIEF DESCRIPTION OF THE DRAWINGS

The above needs are at least partially met through provision of the architecturally-distributed apparatus and method to form and leverage clustered content described in the following detailed description, particularly when studied in conjunction with the drawings, wherein:

FIG. 1 comprises a block diagram as configured in accordance with various embodiments of these teachings; and

FIG. 2 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, pursuant to many of these various embodiments an enabling apparatus can include a first data store having first information stored therein that comprises descriptions of items, a first network interface, and a first control circuit that operably couples to the aforementioned first data store and first network interface. This first control circuit can be configured to process the aforementioned first information to automatically identify a plurality of clusters of related items by, at least in part, pre-processing the first information to provide processed information and to then identify the plurality of clusters of related items by further processing the processed information by, at least in part, vectorizing the processed information to a matrix using term frequency-based vectorization.

By one approach the aforementioned matrix can be converted to a plurality of matrixes using singular value delete decomposition.

By one approach the aforementioned vectorizing comprises calculating at least a first and a second term, where the first term represents how often a term appears in a document and the second term represents a relative importance of the term. By one approach the aforementioned first term represents how often a term appears in a document and the second term represents a relative importance of the term. The aforementioned second term can be calculated as a logarithm of how many documents comprise the processed information divided by how many of the documents include the term.

By one approach the first control circuit processes the first information to automatically identify the plurality of clusters of related items by first using fuzzy intelligence to pre-process the first information to provide processed information and to then identify the plurality of clusters of related items by further processing the processed information. If desired, by one approach the first control circuit uses fuzzy intelligence to pre-process the first information to provide the processed information by pre-processing the first information in combination with a plurality of pre-existing item categorizations.

The enabling apparatus can further include (or at least presume the availability of) a personal communications device having a user interface, a second network interface, a second data store having second information stored therein corresponding to social media postings of a user of the personal communications device, and a second control circuit operably coupled to the user interface, the second network interface, and the second data store. The second control circuit can be configured to carry out a number of corresponding actions.

By one approach the second control circuit determines when a trigger condition exists as a function of the second information. Upon determining the existence of the trigger condition, the second control circuit transmits via the second network interface and to the aforementioned first control circuit a request for information regarding the plurality of clusters of related items. Upon receiving the requested information, the second control circuit uses (for example, by employing deep learning techniques) the second information corresponding to the social media postings of the user to identify at least one of the clusters of related items that corresponds to at least one of the social media postings of the user as an identified cluster.

The second control circuit then communicates information regarding the identified cluster and via the network interface to a remote network element. This remote network element may be the same as the aforementioned first control circuit or may constitute a physically, logically, and legally separate entity. Upon receiving descriptive information (which may comprise, for example, promotional content) regarding at least one of the items that comprises the identified cluster from the remote network element, the control circuit displays the descriptive information via the user interface of the personal communications device.

So configured, a user can receive helpful information regarding the availability of items that are likely to be of current interest to the user while, at the same time, carefully controlling the sharing of the user's social media postings and thereby substantively improving both the reality and perception of the user's privacy.

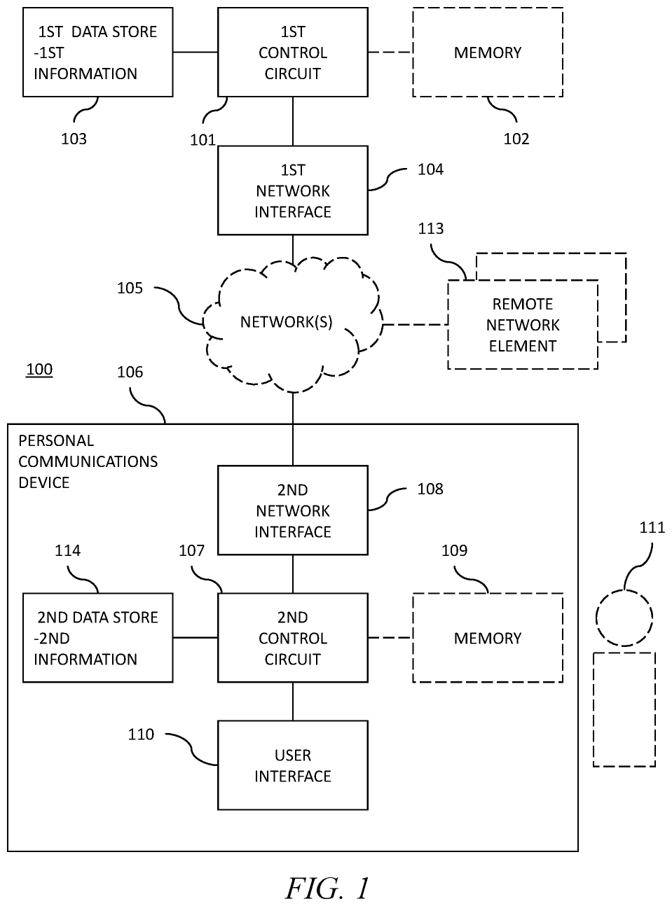

These and other benefits may become clearer upon making a thorough review and study of the following detailed description. Referring now to the drawings, and in particular to FIG. 1, an illustrative enabling apparatus 100 that is compatible with many of these teachings will now be presented. It shall be understood that the specifics of this example are intended to serve an illustrative purpose and are not intended to suggest any particular limitations.

In this illustrative example the apparatus includes a first control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

By one optional approach the control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101).

This memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the first control circuit 101 also operably couples to a first data store 103. This first data store 103 has first information stored therein that comprises descriptions of items. For the sake of an illustrative example it will be presumed here that the plurality of items comprise a plurality of items that are available to purchase (for example, at retail). In the case of a significant retailer, this information may represent and constitute literally millions of different individual items that differ in kind and/or by degree (for example, by size, flavor, color, and so forth). In a typical application setting this first information may be obtained from a variety of different sources including but not limited to manufacturers, distributors, professional and amateur reviews, the retailer itself, customer feedback, and so forth. This first information can be organized, for example, as a plurality of fields using a database format of choice. At a minimum, this information will include a descriptive identifier for each such item.

In this example the control circuit 101 also operably couples to a first network interface 104 that itself couples to one or more communication/data networks 105 (including but not limited to the Internet). Numerous examples are known in the art. A non-exhaustive listing would include Universal Serial Bus (USB)-based interfaces, RS232-based interfaces, I.E.E.E. 1394 (aka Firewire)-based interfaces, Ethernet-based interfaces, any of a variety of so-called Wi-Fi′-based wireless interfaces, Bluetooth™-based wireless interfaces, cellular telephony-based wireless interfaces, Near Field Communications (NFC)-based wireless interfaces, standard telephone landline-based interfaces, cable modem-based interfaces, and digital subscriber line (DSL)-based interfaces.

So configured the control circuit 101 can communicate with other elements (both within the apparatus 100 and external thereto) via the first network interface 104.

In this illustrative example the first control circuit 101 can selectively communicate via the first network interface 104 with a personal communications device 106 that also comprises a part of the apparatus 100. This personal communications device 106 will typically be associated with a corresponding human user 111 and may comprise, for example, a smart phone or a laptop or pad/tablet-style computer.

The personal communications device 106 includes a second control circuit 107 that operably couples to the first control circuit 101 via a second network interface 108. In this example the second control circuit 107 may optionally further operably couple to a memory 109 if desired. This second control circuit 107, second network interface 108, and optional memory 109 may be physically and/or functionally/logically identical or similar to the first control circuit 101, first network interface 104, and optional memory 102 described above.

In this example the second control circuit 107 also operably couples to a user interface 110. This user interface 110 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to the user 111.

For the purposes of this description it is presumed that the personal communications device includes at least one social media application. Examples in these regards include Facebook, Instagram, Goggle+, LinkedIn, and Pinterest, with many other examples being available and with further examples likely to be developed and utilized in the future. Installing and utilizing such social media applications comprises a well understood aspect of prior art teachings. Generally speaking, and relevant to the present teachings, the at least one social media application accommodates user-based social media postings. These postings may constitute text and/or other indications of approval, disapproval, or other feelings, emotions, or conclusions and thoughts.

In this illustrative example the second control circuit 107 also operably couples to a second data store 112. This second data store 112 stores second information that corresponds to at least some of the social media postings of the user 111. By one approach this second information can represent a comprehensive archive of all social media postings by the user 111 that were posted via the personal communications device 106 for at least one social media application and/or for all social media applications hosted by the personal communications device 106.

By another approach this second information may constitute all social media postings made by the user 111 for one or more social media applications via the personal communications device 106 that occurred during a more limited duration of time (for example, during the past hour, day, week, month, or other period of choice). If desired the second control circuit 107 may be configured to provide the user 111 with the ability to specify that duration. So configured, social media postings that occurred outside the relevant period of time are not retained in the second information.

By one approach the second information includes both the literal social media postings of the user 111 along with any relevant context. For example, when the social media posting is the textual string “I completely agree,” the also-stored context may be a statement or other content to which the user 111 was responding with that comment.

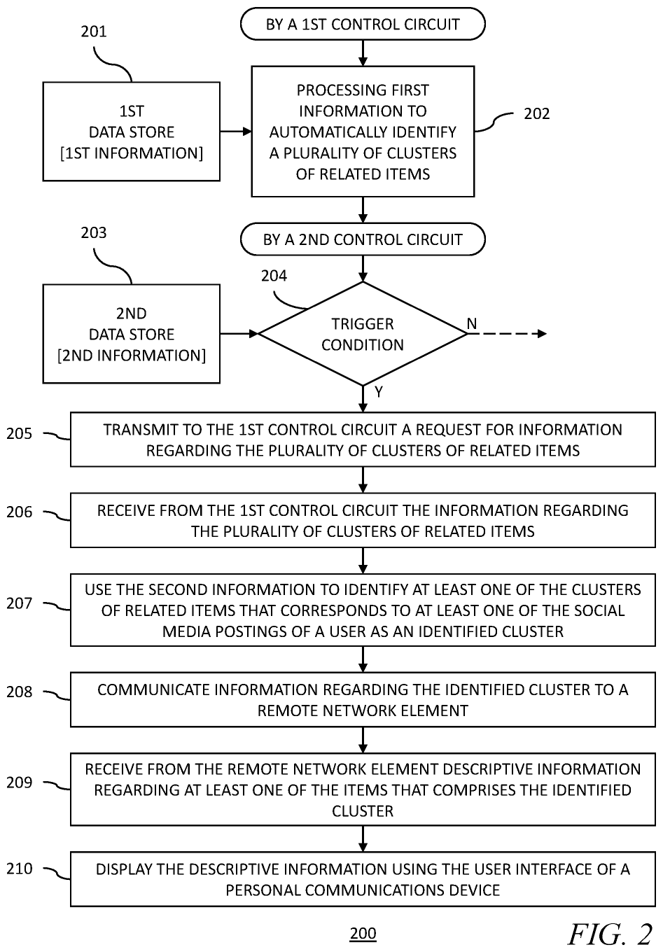

Referring now to FIG. 2, and with continued reference to FIG. 1, a process 200 that can be carried out with such an apparatus 100 will now be described. It will again be understood that the specific details of this description are intended to carry out an illustrative purpose and are not necessarily intended to suggest any particular limitations in these regards.

The aforementioned first control circuit 101 carries out the first part of this process 200 in this example. At block 202 the first control circuit 101 processes the above-described first information 201 to automatically identify a plurality of clusters of related items.

In this example this processing includes, at least in part, pre-processing the first information to provide processed information and to then identify the plurality of clusters of related items by further processing the processed information by, at least in part, vectorizing the processed information to a sparse matrix using term frequency-based vectorization. The latter can further include, by one approach, converting the aforementioned matrix to a plurality of matrixes using singular value decomposition.

By one approach the singular value decomposition of the term frequency matrix serves to decompose the matrix into three matrixes.

A=USV^{T}

Where A is an m×n matrix, U is an m×n orthogonal matrix, S is an n×n diagonal matrix, and V is an n×n orthogonal matrix.

It is also presumed that U and V are orthogonal, that is:

U^{T}U=VV^{T}=I

Where I is the identity matrix. Only the diagonals of the identity matrix are 1, with all other values being 0. Note that because U is not square it cannot be said that U Transpose(U)=I, so U is only orthogonal in one direction.

A significant application of SVD in this case is to decompose the data matrix A close to a matrix of low rank and it is useful to find a low rank matrix which is a good approximation to the data matrix. The SVD represents an expansion of the original data in a coordinate system where the covariance matrix is diagonal.

Calculating the SVD consists of finding the eigenvalues and eigenvectors of AA^{T} and A^{T}A. The eigenvectors of A^{T}A make up the columns of V while the eigenvectors of AA^{T} make up the columns of U. Also, the singular values in S are square roots of eigenvalues from AA^{T} or A^{T}A. The singular values are the diagonal entries of the S matrix and are arranged in descending order. The singular values are always real numbers. If the matrix A is a real matrix, then U and V are also real.

Decomposition of the matrix and finding the singular vectors can be represented as follows:

A=USV^{T} and A^{T}=VSU^{T}

A^{T}A=VSU^{T}USV^{T}

A^{T}A=VS²V^{T}

A^{T}AV=VS²

Thus, by the above process the term document frequency computed above is decomposed into lower dimension feature space using singular value decomposition.

By one approach the control circuit 101 vectorizes the processed information by calculating TF-IDF weights as a function of at least a first term and a second term. The first term constitutes a normalized term frequency (TF) and hence represents how often a term appears in a document divided by the total number of words in that document and the second term constitutes an inverse document frequency (IDF) and hence represents a relative importance of the term in context. (In this example, each of the above-described items is represented by a corresponding “document.”) For example, by one approach the control circuit 101 calculates the second term as a logarithm of how many documents comprise the processed information divided by how many of the documents include the term.

If desired, the aforementioned processing of the first information to automatically identify the plurality of clusters of related items can comprise first using fuzzy intelligence to pre-process the first information to provide processed information and to then identify the plurality of clusters of related items by further processing the processed information. If desired, the use of fuzzy intelligence in these regards can include pre-processing the first information in combination with a plurality of pre-existing item categorizations. By one approach, current categories for items along with corresponding item descriptions are combined with fuzzy intelligence while optimizing corresponding weighting. Using this approach, one can readily provide for the most important and key words receiving priority in the resultant corpus.

Generally speaking, per the above-described process, once the term-frequency modified with singular value decomposition features have been extracted, hierarchical clustering is used to cluster them into a user intent basket. This can comprise hierarchical agglomerative clustering with TF-IDF modified features. Hierarchical clustering algorithms are either top-down or bottom-up. Bottom-up algorithms treat each document as a singleton cluster at the outset and then successively merge (or agglomerate) pairs of clusters until all clusters have been merged into a single cluster that contains all documents. Bottom-up hierarchical clustering is therefore called hierarchical agglomerative clustering or HAC. Top-down clustering requires a method for splitting a cluster. It proceeds by splitting clusters recursively until individual documents are reached. HAC is more frequently used in IR than top-down clustering. The present teachings presume use of Top-down hierarchy to implement clustering of items into user intent baskets.

By one approach dendrograms can be utilized to determine optimal clusters. The average distance between clusters and along a horizontal axis on which the clusters are formed can be calculated, and hence one can optimize based on such a distance. Using such information one can decide on the optimal number of clusters.

These teachings presume that the automatic identification of clusters of related items includes tagging or otherwise associating those clusters with one or more corresponding descriptions of the basis for cluster membership.

So configured, the resultant identified clusters can represent clusters of items that associate the items as a function of one or more tying qualities, features, or other attributes. As one simple example in these regards, one cluster of items might include bedsheets, T-shirts, backpacks, partyware, and first aid supplies that all include the image of a particular comic book superhero. As another simple example in these regards, another cluster of items might include certain items of sportswear, drinking water flasks, lightweight tools, wearable sources of illumination, and certain edible energy sources that may all be useful in the context of long-distance bicycle riding. And as yet another simple example in these regards, yet another cluster of items defined by leisure boating activities might include boat accessories as well as various food and drink items that, by packaging, storage requirements, or otherwise are particularly well-suited to use in a leisure boating context.

In this illustrative example many of the remaining activities are carried out by the above-described second control circuit 107 that comprises a part of the above-described personal communications device 106.

At block 204 the second control circuit 107 utilizes the above-described second information 203 to determine when a predetermined trigger condition exists. As described above, the second information 203 corresponds to social media postings by the user 111. The second control circuit 107 is therefore determining the existence of a trigger condition as a function of the user's social media postings.

These teachings will accommodate a variety of approaches in the foregoing regards. By one approach, the posting of any social media content can constitute the requisite trigger condition. By another approach, only certain kinds of postings, such as text-based postings, can constitute the trigger condition. By yet another approach, only postings that constitute a reaction to an existing posting by another entity can constitute the trigger condition. And by yet another approach only postings that constitute an original posting by the user 111 can constitute the requisite trigger condition. Many other possibilities are available.

These teachings will also accommodate a more analytical view of any given social media posting as part of determining the existence of a trigger condition. For example, a given social media posting can be analyzed to detect the presence or absence of required content regarding some expression of approval or disapproval in context with some subject of that approval/disapproval. A social media posting that lacks such content can fail to rise to the level of the predetermined trigger condition.

These teachings will also accommodate analyzing social media postings in context with other social media postings by the user 111. For example, the trigger condition may require at least three postings within some predetermined period of time (such as one week or one month) that all, to a greater or lesser extent, indicate approval or disapproval of a given subject.

The foregoing determination of the existence of a trigger condition can be as relatively straightforward or as nuanced as may be desired. For example, by one approach, only declaratory statements that are clearly and directly tied to a corresponding subject may qualify in these regards. By another approach, less direct and/or inferential conclusions may be also utilized if desired, potentially with corresponding weighting to reflect the confidence of any conclusions based upon the automated interpretation of such content.

In the absence of detecting a trigger condition this process 200 can accommodate any of a variety of responses. Examples of responses can include temporal multitasking (pursuant to which the personal communications device conducts other tasks before returning to again monitor for a trigger condition) as well as continually looping back to essentially continuously monitor for a trigger condition. These teachings also accommodate supporting this determination activity via a real-time interrupt capability.

Upon detecting a trigger condition, at block 205 the second control circuit 107 transmits to the first control circuit 101, via the second network interface 108, a request for information regarding the plurality of clusters of related items. This request can include one or more textual expressions that are gleaned from or that otherwise represent the subject of a statement posted by the user 111. For example, if the user 111 posted a social media statement saying, “I can't wait to see the new Captain Dishwasher movie this weekend, he's my favorite superhero!”, the aforementioned request can include the expression “Captain Dishwasher.” By one approach this representative content can constitute one or more expressions that appear verbatim in the social media posting. By another approach, in combination with the foregoing or in lieu thereof, the representative content can constitute one or more derived expressions that are based upon but that do not appear verbatim in the social media posting.

Upon receiving this communication, the first control circuit 101 identifies one or more of the previously identified clusters of related items that are responsive to the request. In some cases only a single cluster might match the inquiry. In other cases a number of clusters might match the inquiry to a greater or lesser degree. In the latter case the identified clusters may be placed in an order of relevance, where the relevance, if desired, can be expressed or otherwise represented by a metric (such as a number) that represents a perceived degree of relevance.

The first control circuit 101 then transmits the requested information by way of transmitting information regarding one or more identified clusters along with at least some of the items that pertain to the identified cluster(s). The information for the items may include information such as a stock keeping unit (SKU) number, the manufacturer's identity, the name of the item, and so forth. Generally speaking, and in a typical application setting, it can be beneficial to minimize the volume of this information to thereby minimize bandwidth requirements. By one approach, and especially when only a single cluster corresponds to the request, the responding communication may not include any identifying information for the cluster itself and instead may only include identifying information for one or more of the items that constitute the cluster.

At block 206 the second control circuit 107 receives the information provided by the first control circuit 101 in these regards. At block 207 the second control circuit 107 uses the second information 203 that corresponds to the social media postings of the user 111 to identify at least one of the clusters of related items (which may, if desired, include identifying an item within such a cluster) that corresponds to at least some predetermined sufficient degree to at least one of the social media postings of the user as an identified cluster.

By one approach the foregoing activity makes use of so-called deep learning (sometimes also known in the art as deep structured learning or hierarchical learning) to make the aforementioned identification. Deep learning methods are based on learning data representations (as versus, for example, task-specific algorithms). Various architectural approaches are known in the art and include deep neural networks, recurrent neural networks, and deep belief networks, to note but a few examples.

At block 208 the second control circuit 107 communicates information regarding the identified cluster to a remote network element 113 via the second network interface 108. The information conveyed may simply constitute identifying information for one or more items that constituted a part of the relevant cluster. By another approach information that identifies the cluster itself may be included in this communication. The remote network element 113 may be physically and logically distinct from the first control circuit 101 and may be owned and/or controlled by a different entity than the entity that operates the first control circuit 101 (and hence legally differentiated). In the alternative, if desired, the remote network element 113 and the first control circuit 101 may be one and the same.

The remote network element 113 utilizes the information provided by the second control circuit 107 to identify and access descriptive information for one or more of the items that comprise the identified cluster. This descriptive information may comprise, at least in part, promotional content such as, but not limited to, manufacturer's specifications, user manuals, pricing information, user reviews, professional reviews, warranty information, availability and shipping information, information regarding components/ingredients and/or country of origin, and so forth as desired.

At block 209 the second control circuit 107 receives from the remote network element 113 the aforementioned descriptive information. And at block 210 the second control circuit 107 displays at least part of the received descriptive information using the user interface 110 of the personal communications device 106. These teachings will accommodate a variety of approaches in these regards. By one approach the received information can be at least partially displayed at or shortly following the time of receipt along with a corresponding user alert if desired. By another approach, the received information can be at least partially displayed the next time the user 111 accesses a particular application or personal communications device feature.

By one approach the displayed information is sufficient to permit the user 111 to not only become informed regarding the one or more items but to also facilitate the user 111 ordering the item with only a minimal number of follow-on commands or actions.

While the illustrative example presented above presumes that the items comprise products available for purchase, these teachings will readily accommodate other items and application settings. As one example, the items could constitute various medical supplies and the clusters can represent various medical procedures, operations, and treatments. As another example, the items could constitute various military supplies and provisions while the clusters represent various military tactical operations. And as yet another example, the items could represent various components and supplies while the clusters represent various repair and maintenance scenarios for various apparatuses such as aircraft, vehicles, residences, and so forth.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
a first data store having first information stored therein that comprises descriptions of a plurality of items;
a first network interface;
a first control circuit operably coupled to the first data store and to the first network interface and configured to process the first information to automatically identify a plurality of clusters of related items by, at least in part, pre-processing the first information to provide processed information and to then identify the plurality of clusters of related items by further processing the processed information by, at least in part, vectorizing the processed information to a matrix using term frequency-based vectorization;
a personal communications device having a user interface, a second network interface, a second data store having second information stored therein corresponding to social media postings of a user of the personal communications device, and a second control circuit operably coupled to the user interface, the second network interface, and the second data store, the second control circuit being configured to:
determine when a trigger condition exists as a function of the second information;
upon determining that the trigger condition exists, transmitting via the second network interface to the first control circuit a request for information regarding the plurality of clusters of related items;
receive from the first control circuit via the network interface the information regarding the plurality of clusters of related items;
use the second information corresponding to the social media postings of the user to identify at least one of the clusters of related items that corresponds to at least one of the social media postings of the user as an identified cluster;
communicate information regarding the identified cluster via the network interface to a remote network element;
receiving from the remote network element via the network interface descriptive information regarding at least one of the items that comprises the identified cluster;
displaying the descriptive information using the user interface of the personal communications device.

2. The apparatus of claim 1 wherein the first control circuit is configured to process the first information to automatically identify the plurality of clusters of related items by first using fuzzy intelligence to pre-process the first information to provide processed information and to then identify the plurality of clusters of related items by further processing the processed information.

3. The apparatus of claim 2 wherein the first control circuit is configured to use the fuzzy intelligence to pre-process the first information to provide the processed information by pre-processing the first information in combination with a plurality of pre-existing item categorizations.

4. The apparatus of claim 1 wherein the first control circuit is configured to vectorize the processed information by calculating at least a first and a second term, where the first term represents how often a term appears in a document and the second term represents a relative importance of the term.

5. The apparatus of claim 4 wherein the first control circuit is configured to calculate the second term as a logarithm of how many documents comprise the processed information divided by how many of the documents include the term.

6. The apparatus of claim 1 wherein the first control circuit is further configured to convert the matrix to a plurality of matrixes using singular value decomposition.

7. The apparatus of claim 1 wherein the plurality of items comprises a plurality of items that are available to purchase.

8. The apparatus of claim 7 wherein the first information is obtained from a variety of different sources.

9. The apparatus of claim 1 wherein the descriptive information comprises, at least in part, promotional content.

10. A method comprising:
by a first control circuit that is operably coupled to a first network interface and a first data store having first information stored therein that comprises descriptions of a plurality of items:
processing the first information to automatically identify a plurality of clusters of related items by, at least in part, pre-processing the first information to provide processed information and to then identify the plurality of clusters of related items by further processing the processed information by, at least in part, vectorizing the processed information to a matrix using term frequency-based vectorization;
by a second control circuit that comprises a part of a personal communications device having a user interface, a second network interface, and a second data store having second information stored therein corresponding to social media postings of a user of the personal communications device, wherein the second control circuit operably couples to the user interface and the second data store:
determining when a trigger condition exists as a function of the second information;
upon determining that the trigger condition exists, transmitting via the second network interface to the first control circuit a request for information regarding the plurality of clusters of related items;
receiving from the first control circuit via the network interface the information regarding the plurality of clusters of related items;
using the second information corresponding to the social media postings of the user to identify at least one of the clusters of related items that corresponds to at least one of the social media postings of the user as an identified cluster;
communicating information regarding the identified cluster to a remote network element via the second network interface;
receiving from the remote network element via the second network interface descriptive information regarding at least one of the items that comprises the identified cluster;
displaying the descriptive information using the user interface of the personal communications device.

11. The method of claim 10 wherein processing the first information to automatically identify the plurality of clusters of related items comprises first using fuzzy intelligence to pre-process the first information to provide processed information and then identifying the plurality of clusters of related items by further processing the processed information.

12. The method of claim 11 wherein using the fuzzy intelligence to pre-process the first information to provide the processed information comprises pre-processing the first information in combination with a plurality of pre-existing item categorizations.

13. The method of claim 10 wherein vectorizing the processed information comprises calculating at least a first and a second term, where the first term represents how often a term appears in a document and the second term represents a relative importance of the term.

14. The method of claim 13 further comprising:
calculating the second term as a logarithm of how many documents comprise the processed information divided by how many of the documents include the term.

15. The method of claim 10 further comprising:
converting the matrix to a plurality of matrixes using singular value decomposition.

16. The method of claim 10 wherein the plurality of items comprises a plurality of items that are available to purchase.

17. The method of claim 16 wherein the first information is obtained from a variety of different sources.

18. The method of claim 10 wherein the descriptive information comprises, at least in part, promotional content.
